(19) United States
(12) Patent Application Publication
(10) Pub. No.: US 2021/0106939 A1
(43) Pub. Date: Apr. 15, 2021

(54) CLEANER UNIT

(71) Applicant: KAWASAKI JUKOGYO KABUSHIKI KAISHA, Kobe-shi (JP)

(72) Inventor: Gouki Takano, Grand Rapids, MI (US)

(21) Appl. No.: 16/856,936

(22) Filed: Apr. 23, 2020

Related U.S. Application Data
(60) Provisional application No. 62/913,911, filed on Oct. 11, 2019.

(51) Int. Cl. B01D 50/00; B04C 9/00; B01D 46/10; B01D 45/16; B01D 39/12

(52) U.S. Cl. CPC B01D 50/002; B04C 9/00; B04C 2009/004; B01D 45/16; B01D 39/12; B01D 46/106

(57) ABSTRACT

A cleaner unit of the present invention is intended to be used in a cyclone air cleaner in which the cleaner unit includes a cleaner element and a resin net, wherein the cleaner unit has a cylindrical shape and is configured to cause outside air to swirl around an outer periphery of the cleaner unit and to be introduced through the cleaner element into a hollow part defined inside the element so as to remove dust. The cleaner element has an outer periphery covered by the resin net including an outer periphery part and a plurality of mesh openings, at least the outer periphery part being made of a resin.

### CROSS REFERENCE TO THE RELATED APPLICATION

This application claims the benefit of U.S. Provisional Patent Application No. 62/913,911, field Oct. 11, 2019, the contents of which are hereby incorporated by reference.

### BACKGROUND OF THE INVENTION

### Field of the Invention

The present invention relates to a cleaner unit having a cylindrical shape for a cyclone air cleaner.

### Description of Related Art

For example, engines for mowers equipped with a cyclone air cleaner have been known. The cyclone air cleaner causes outside air to swirl around an outer periphery of a cleaner unit having a cylindrical shape and to be introduced through a cleaner element into a hollow part defined inside the cleaner element so as to remove dust. Such a cleaner unit uses, for example, filter paper as such a cleaner element, the outer periphery of which is protected by wire mesh.

The cyclone air cleaner separates dust sucked with cyclone flow into grass clippings and dirt and the like, so as to discharge the grass clippings to the outside of the air cleaner while discharging the dirt and the like to the outside and/or collecting it in the cleaner element in accordance with different sizes. When the cyclone flow is weak during, in particular, low-speed rotation of the engine, however, grass clippings may stick to the wire mesh. Sticking of the grass clippings to the wire mesh may disturb air flow, resulting in deterioration of performance of the cleaner element. Air cleaners have been known in which urethane foam (sponge) is wound around outer peripheries of wire mesh as a prefilter. However, in such a case, grass clippings may stick to the urethane foam. Also, air cleaners have been known in which a prefilter formed of, e.g., a non-woven fabric is removably attached to outer peripheries of wire mesh such that the prefilter on which grass clippings have been accumulated can be replaced (for example, JP Laid-open Patent Publication No. 2007-071072).

The air cleaner in JP Laid-open Patent Publication No. 2007-071072, however, does not intend to prevent sticking of grass clippings. Therefore, in cases where a lot of grass clippings stick to a prefilter, the prefilter has to be frequently replaced. In addition, if replacement of the prefilter is forgotten, performance of the element may be deteriorated.

### SUMMARY OF THE INVENTION

An object of the present invention is to provide a cleaner unit capable of preventing dust, such as grass clippings, from sticking thereto.

In order to achieve the above object, the present invention provides a cleaner unit for a cyclone air cleaner, the cleaner unit including a cleaner element and a resin net, wherein the cleaner unit has a cylindrical shape and is configured to cause outside air to swirl around an outer periphery of the cleaner unit and to be introduced through the cleaner element into a hollow part defined inside the cleaner element so as to remove dust, and the cleaner element has an outer periphery covered by the resin net including an outer periphery part and a plurality of mesh openings, at least the outer periphery part being made of a resin. The mesh openings may be, for example, rectangular, circular, elliptical, or rhombic in shape.

According to this configuration, since the outer periphery of the cleaner element is covered by the resin net, dust such as grass clippings slides over a surface of the resin net without being caught by a filter unit and is carried with cyclone flow to be discharged to the outside of the air cleaner. This makes it possible to prevent dust such, as grass clippings, from sticking to the cleaner element. Consequently, it is possible to prevent deterioration of performance of the filter unit.

In the present invention, each of the mesh openings may have corner parts each forming a curved surface. According to this configuration, each of the corner parts of the mesh openings is in the form of a curved surface, that is, has a round shape. This reduces the amount of the grass clippings caught by the resin net. Thus, it is possible to prevent the grass clippings from sticking to the cleaner element.

In the present invention, the resin net may be formed of wire mesh covered with the resin. This configuration makes it possible to reinforce the cleaner unit with the wire mesh and to prevent grass clippings from sticking to the wire mesh.

In the present invention, the cleaner element may include bent filter paper. According to this configuration, such a cleaner element including filter paper and having low strength can be protected by the resin net.

In the present invention, a swirling passage between an outer peripheral surface of the cleaner element and an inner peripheral surface of a cleaner case may have a larger cross-sectional area than a cross-sectional area of a filter part of the cleaner element. According to this configuration, the increased cross-sectional area of the swirling passage increases the flow rate of the cyclone flow. This facilitates discharge of the grass clippings.

Any combination of at least two constructions disclosed in the appended claims and/or the specification and/or the accompanying drawings should be construed as included within the scope of the present invention. In particular, any combination of two or more of the appended claims should be equally construed as included within the scope of the present invention.

### BRIEF DESCRIPTION OF THE DRAWINGS

The present invention will be more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views:

FIG. 1 is a front view of an engine including a cleaner unit according to a first embodiment of the present invention;

FIG. 2 is a plan view of the engine;

FIG. 3 is a cross-sectional view of the engine;

FIG. 4 is a perspective view illustrating a state where a cleaner case of the engine is removed;

FIG. 5 is a plan view of a fan case of the engine;

FIG. 6 is a longitudinal-sectional view of the fan case and the cleaner unit;

FIG. 7 is a front view of the cleaner unit;

FIG. 8 is a perspective view illustrating a state where a part of the cleaner case of the engine is removed;

FIG. 9 is a perspective view of the fan case and the cleaner case;

FIG. 10 is a plan view of a resin net of the cleaner unit;

FIG. 11 is a sectional view taken along line XI-XI in FIG. 10; and

FIG. 12 is a cross-sectional view of the cleaner unit.

### DESCRIPTION OF THE EMBODIMENTS

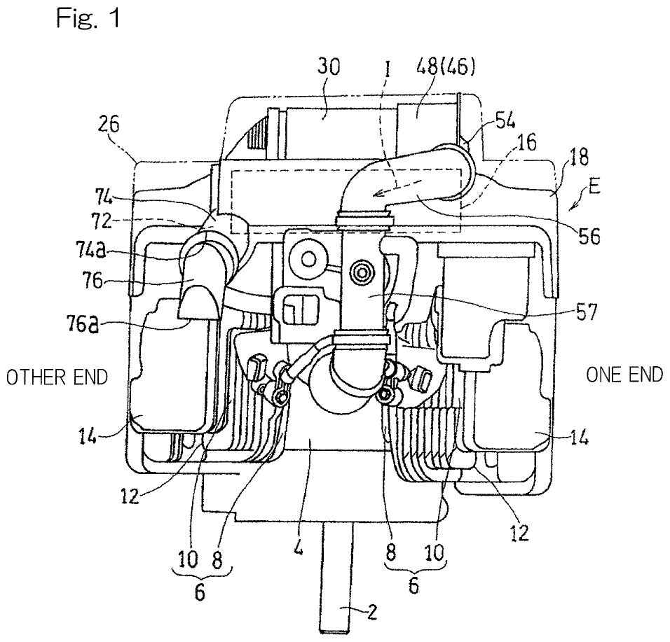

Hereinafter, preferred embodiments of the present invention will be described with reference to the drawings. In FIG. 1, an engine E including a cleaner unit according to a first embodiment of the present invention is mounted on, for example, a riding mower including an air-cooled vertical-twin engine having a rotation shaft extending in a vertical direction. It should be noted that the type of the engine E and the application of the engine E are not limited to the those described herein.

The engine E of the present embodiment includes: a crankshaft 2 that forms a rotation shaft extending in an up-and-down direction or vertical direction; a crankcase 4 supporting the crankshaft 2; and a pair of cylinder units 6, 6 protruding forward from a front part of the crankcase 4. The crankshaft 2 has a lower end part configured to be attached with a work tool, such as a mower blade.

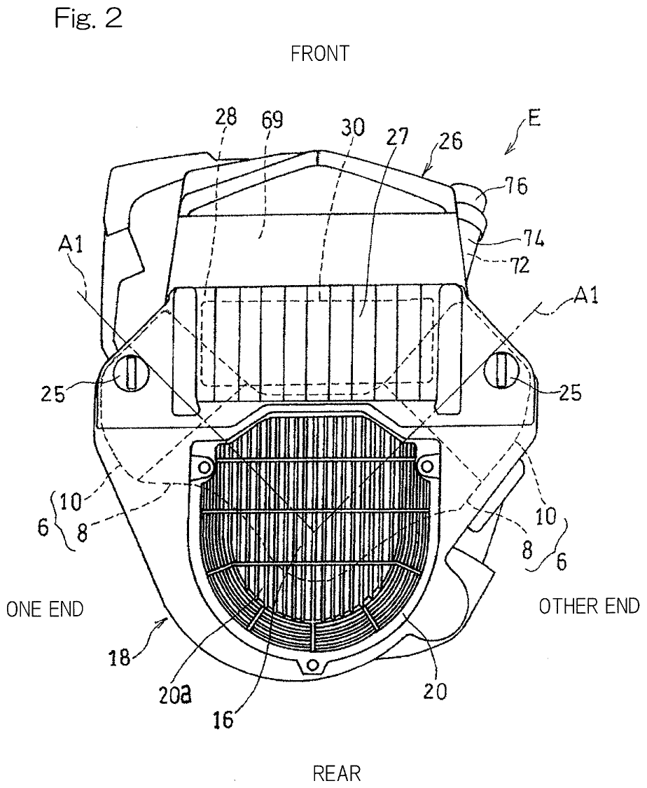

Each of the cylinder units 6 includes: a cylinder 8 coupled to the crankcase 4; and a cylinder head 10 coupled to a front end of the cylinder 8. As shown in FIG. 2, each of the cylinder units 6 has a cylinder axis A1 extending forward in an outwardly slanting manner. That is, the cylinder axes A1 of the two cylinder units 6 form a V shape opened forward.

As shown in FIG. 1, each of the cylinder units 6 has an outer periphery formed with a cooling fin 12. The cooling fin 12 increases a surface area so as to enhance cooling effect of the air-cooled engine. Each of the cylinder units 6 has a front end to which a head cover 14 is attached.

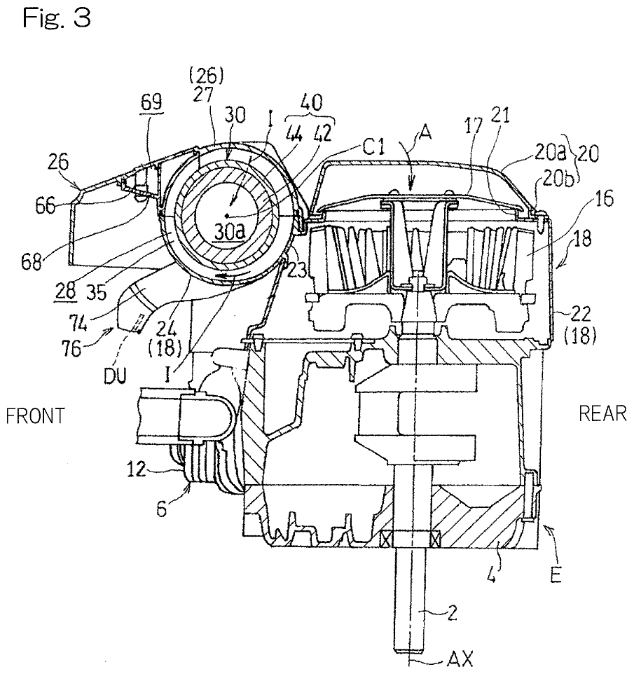

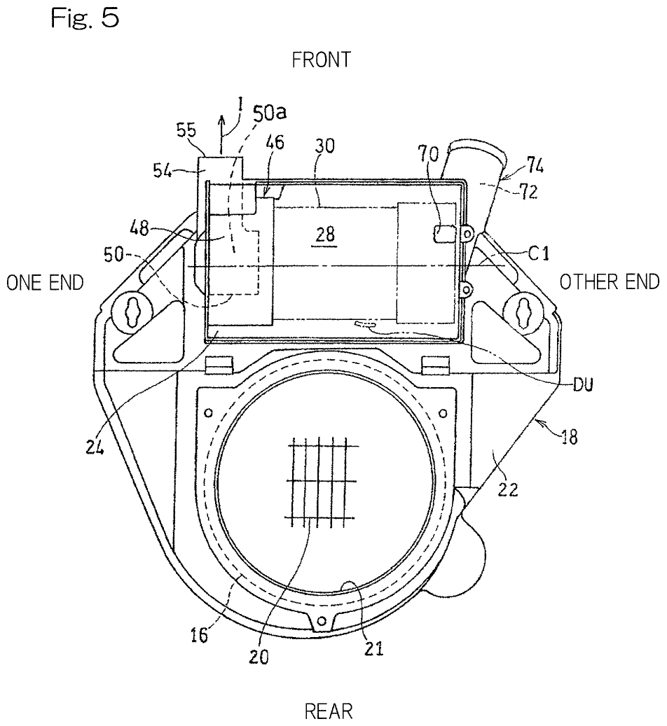

As shown in FIG. 3, the crankshaft 2 has an upper end to which a cooling fan 16 is attached. The cooling fan 16 has an upper end to which a rotary screen 17 is attached. The crankcase 4 has an upper end portion to which a fan case 18 is attached. As shown in FIG. 5, the fan case 18 includes: a fan housing part 22 covering the cooling fan 16; and an element receiving part 24 provided on a front side of the fan housing part 22. The fan case 18 is a molded article made of a resin, in which the fan housing part 22 and the element receiving part 24 are integrally formed.

As shown in FIG. 3, the fan housing part 22 of the fan case 18 covers an upper side and an outer periphery of the cooling fan 16, except for a front side of the cooling fan 16. The front side of the cooling fan 16 is covered by a part (rear wall 23) of the element receiving part 24.

The fan housing part 22 of the fan case 18 is formed with a cooling air intake port 21 opened upward. The rotary screen 17 is disposed above the cooling air intake port 21. The fan housing part 22 has an upper surface on which a fan cover 20 is attached. The fan cover 20 covers the cooling air intake port 21 and the rotary screen 17 from above. The fan cover 20 includes: a lattice-like screen member 20a; and a frame part 20b forming an outer peripheral edge of the screen member 20a. That is, air A can pass through the screen member 20a of the fan cover 20 and flow into the fan case 18, whereas foreign matters larger than lattice openings of the screen member 20a cannot pass through the fan cover 20.

When the engine E starts operating and causes the crankshaft 2 to rotate, the cooling fan 16 and the rotary screen 17 are integrally rotated together with the crankshaft 2. As the cooling fan 16 rotates, air A is sucked into the fan case 18 through the cooling air intake port 21. The air A flowing into the fan case 18 is guided by the fan case 18 and flows downward to cool the cooling-target components, such as the cylinder units 6, 6. Although grass clippings and the like smaller than the lattice openings of the screen member 20a pass through the fan cover 20, such grass clippings and the like are cut out by the rotary screen 17 and are discharged to the outside from a gap between the crankcase 4 and the fan case 18.

The element receiving part 24 of the fan case 18 has a semi-cylindrical shape opened upward. The semi-cylindrical element receiving part 24 has the center axis C1 extending in a widthwise direction perpendicular to the axis AX of the crankshaft 2.

The fan case 18 is attached with a cleaner case 26. Specifically, the cleaner case 26 is removably attached to an upper surface of the fan case 18 by a fitting tool 25 (FIG. 2). In this embodiment, the cleaner case 26 is a molded article made of a resin. The cleaner case 26 includes an element cover part 27 that has a semi-cylindrical shape opened downward. The semi-cylindrical element cover part 27 is coaxial with the element receiving part 24 (at the center axis C1) and has the same radius as that of the element receiving part 24.

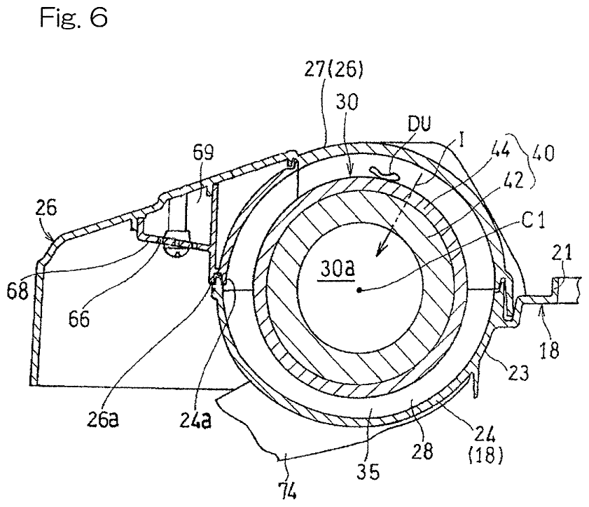

That is, as shown in FIG. 6, two end faces 24a of the element receiving part 24 of the fan case 18 and two end faces 26a of the element cover part 27 of the cleaner case 26 are abutted with each other so as to form a cylindrical shape having the center axis C1. This cylinder defines an inner space as a cleaner chamber 28. In other words, the cleaner chamber 28 is defined between the element receiving part 24 of the fan case 18 and the element cover part 27 of the cleaner case 26.

The cleaner chamber 28 and the inner space of the element receiving part 24 of the fan case 18 are separated or partitioned by the rear wall 23. That is, the air A generated by the cooling fan 16 does not flow into the cleaner chamber 28.

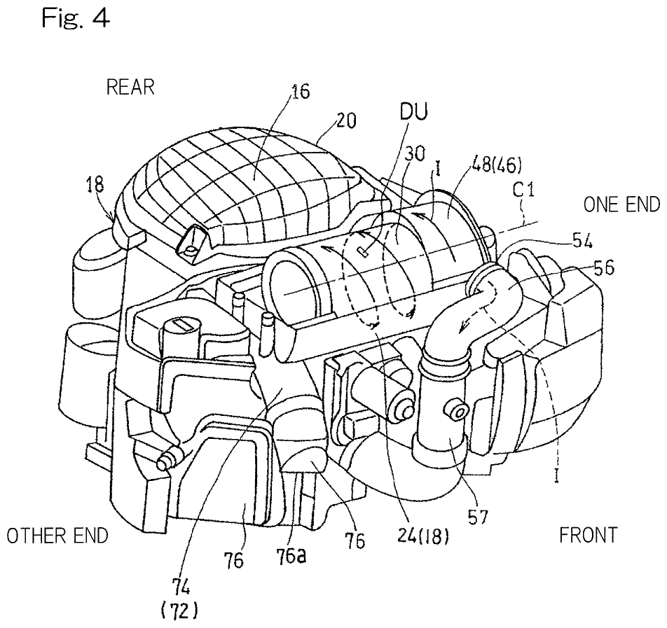

The cleaner chamber 28 houses or accommodates a cleaner unit 30 having a cylindrical shape. A swirling passage 35 is defined around an outer periphery of the cleaner unit 30 in the cleaner chamber 28. The swirling passage 35 is defined between an outer peripheral surface of the cleaner unit 30, and an inner peripheral surface of the element receiving part 24 and an inner peripheral surface of the element cover part 27 of the cleaner case 26. As shown in FIG. 4, outside air, that is introduced as intake air I of the engine E, flows in the direction of the center axis C1 while swirling in the swirling passage 35 around the outer periphery of the cleaner unit 30. The intake air I flows within the swirling passage 35 from one end (right-hand side in FIG. 4) to the other end (left-hand side in FIG. 4).

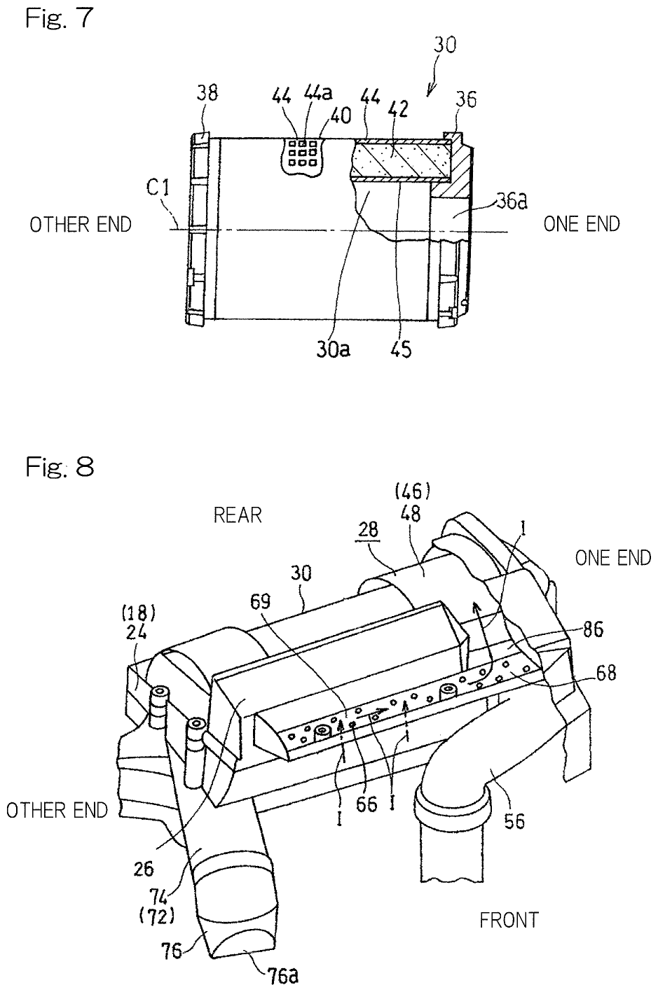

The cleaner unit 30 purifies the intake air I of the engine E. As shown in FIG. 7, the cleaner unit 30 includes: first and second retaining parts 36, 38 at the opposite ends in an axial direction; and a filter part 40 between the first and second retaining parts 36, 38. The first retaining part 36 is formed at one end portion (right-hand side in FIG. 7) of the cleaner unit 30, and the second retaining part 38 is formed at the other end portion (left-hand side in FIG. 7) of the cleaner unit 30. In this embodiment, the first and second retaining parts 36, 38 are made of a resin. The first retaining part 36 has an open end face, whereas the second retaining part 38 has a closed end face. That is, the hollow part 30a of the cleaner unit 30 is opened toward the one-end side via an opening 36a of the first retaining part 36.

As shown in FIG. 3, the filter part 40 includes a cleaner element 42 for removing dust. In this embodiment, the cleaner element 42 includes bent filter paper. It should be noted that the material of the cleaner element 42 is not limited to this. The cleaner element 42 has an outer periphery covered by a resin net 44. The resin net 44 includes an outer periphery part and a plurality of mesh openings 44a (FIG. 7), at least the outer periphery part being made of a resin. The resin net 44 will be described later in detail. The intake air I flowing within the swirling passage 35 passes through the resin net 44 and the cleaner element 42 so as to be purified and flows into the hollow part 30a of the cleaner unit 30.

That is, the air cleaner of the present embodiment is a cyclone air cleaner in which the outside air is caused to swirl around the outer periphery of the cleaner unit 30 having a cylindrical shape and to pass through the cleaner element 42 into the hollow part 30a defined inside the cleaner element 42 so as to remove dust.

As shown in FIG. 5, a guide member 46 protruding inside the cleaner chamber 28 is formed at one end portion (left-hand side in FIG. 5) of the element receiving part 24 of the fan case 18. The guide member 46 has a cylindrical shape that is coaxial with the center axis C1 of the fan housing part 24, and is integrally formed with the fan housing part 24. The guide member 46 may be integrally formed with the element cover part 27 of the cleaner case 26. Specifically, the guide member 46 includes a retaining part 48 having a large diameter and an insertion pipe 50 having a small diameter.

A cleaner outlet pipe 54 is formed on one-end side of the insertion pipe 50. The cleaner outlet pipe 54 extends forward to define an outlet opening 55. The cleaner outlet pipe 54 is also integrally formed with the element receiving part 24. The intake air I having flowing into the insertion pipe 50 from the hollow part 30a (FIG. 3) of the cleaner unit 30 is directed to the outside of the cleaner chamber 28 through the cleaner outlet pipe 54.

As shown in FIG. 4, the cleaner outlet pipe 54 is connected with an intake pipe 56. The intake air I from the cleaner outlet pipe 54 passes through the intake pipe 56 and is supplied to a throttle body 57 of the cylinder units 6, 6.

As shown in FIG. 3, the cleaner case 26 has a front part formed with an intake port 66. The intake port 66 takes air outside the cleaner case 26, i.e., outside air, into the swirling passage 35. Specifically, the intake port 66 takes air outside the cleaner case 26 and outside the fan case 18 into the swirling passage 35. In this embodiment, the intake port 66 faces downward. It should be noted that the orientation of the intake port 66 is not limited to this.

The intake port 66 is attached with a screen 68 for removing foreign matters. The screen 68 is formed in a mesh form and prevents foreign matters, such as grass clippings, from entering the cleaner chamber 28. Since the intake port 66 faces downward, the matters screened by the screen 68 falls downward. An introduction passage 69 is defined outside the cleaner chamber 28, e.g., on a front side of the cleaner chamber 28 in this embodiment.

The introduction passage 69 is defined between the intake port 66 and the cleaner chamber 28. The introduction passage 69 introduces the air having passed through the screen 68 into one end portion of the cleaner chamber 28 and causes the air to swirl. As shown in FIG. 8, the introduction passage 69 extends on the front side of the cleaner chamber 28 from the other end portion to the one end portion.

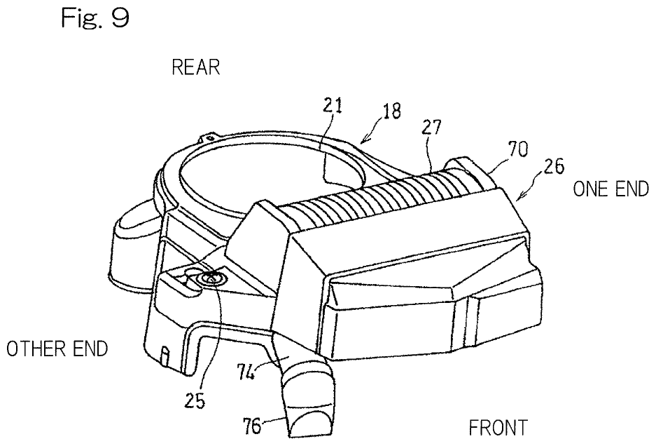

FIG. 8 is a perspective view illustrating a state where a part of the cleaner case 26 is omitted. FIG. 9 is a perspective view of the cleaner case 26 and the fan case 18 when obliquely viewed from a front and upper side. As shown in FIG. 8, the introduction passage 69 has one end portion formed with a communication port 86 for communicating with the one end portion of the cleaner chamber 28.

As shown in FIG. 5, a dust discharge port 70 is defined at the other end portion of the cleaner chamber 28. Specifically, the dust discharge port 70 is defined outward (on the other end side), in the axial direction C1, of the cleaner unit 30 in the cleaner chamber 28. The dust discharge port 70 is provided in the other end portion of the element receiving part 24 of the fan case 18 and forward of the center axis C1. In this embodiment, the dust discharge port 70 is in the form of a rectangular opening. The dust discharge port 70 discharges dust DU within the cleaner chamber 28 into a dust discharge passage 72.

The element receiving part 24 of the fan case 18 is formed with a dust discharge pipe 74. The dust discharge pipe 74 defines the dust discharge passage 72 that communicates with the dust discharge port 70. The dust discharge pipe 74 includes a cylindrical pipe and protrudes forward from the element receiving part 24 of the fan case 18. Specifically, as shown in FIG. 1, the dust discharge pipe 74 extends forward and obliquely downward from a lower part, on the other end side, of the element receiving part 24. In this embodiment, the dust discharge pipe 74 is integrally formed with the element receiving part 24.

The dust discharge pipe 74 has an outlet 74a at its front end, to which a one-way valve 76 as shown in FIG. 3 is attached. In this embodiment, a duckbill valve is used as the one-way valve 76. It should be noted that the one-way valve 76 is not limited to this configuration.

The one-way valve 76 opens and closes in accordance with pressure change during engine operation. While the valve is closed, the dust DU is accumulated inside the one-way valve 76. When the valve is opened, the dust DU is discharged due to pressure change. In this embodiment, the outlet 76a of the one-way valve 76 faces downward so as to effectively discharge the dust DU. The dust DU that flows into the dust discharge passage 72 within the dust discharge pipe 74 from the dust discharge port 70 is discharged to the outside through the one-way valve 76.

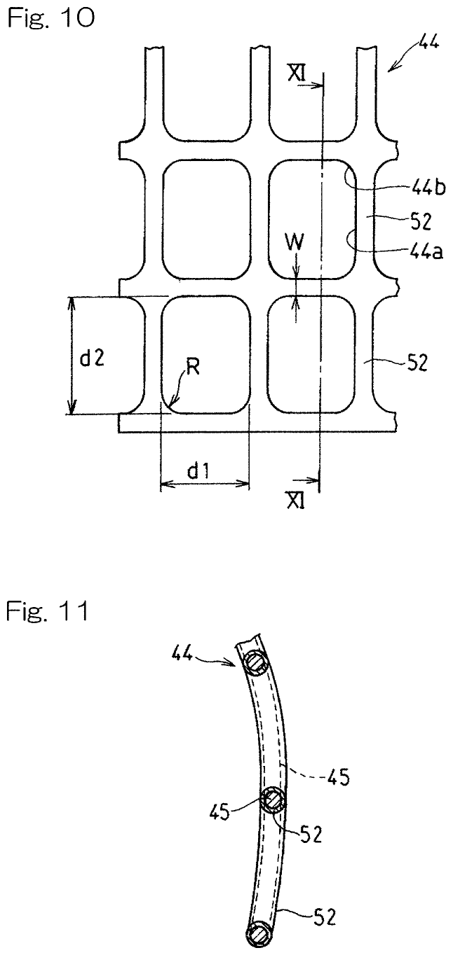

The resin net 44 will be described. The resin net 44 as shown in FIG. 7 includes an outer periphery part and a plurality of mesh openings 44a, and at least the outer periphery part is made of a resin. Specifically, the resin net 44 includes linear members 52 that linearly extend and intersect with each other in a lattice-like manner, and the mesh openings 44a is surrounded by the linear members 52. Each of the mesh openings 44a in this embodiment has a rectangular shape. It should be noted that the shape of each mesh opening 44a is not limited to the rectangular form and may be, for example, in a circular, elliptical, or rhombic shape. As shown in FIG. 10, each of the mesh openings 44a has corner parts 44b each forming a curved surface in this embodiment. In other words, each of the corner parts 44b of the mesh openings 44a has a round shape.

As shown in FIG. 7, the element (filter paper) 42 has an inner peripheral surface and an outer peripheral surface that are protected by wire mesh 45 made of steel. The resin net 44 of the present embodiment as shown in FIG. 11 is formed of the wire mesh 45 covered with the resin. Specifically, the resin net 44 of the present embodiment is formed by casting the wire mesh 45 in the resin. That is, the resin net 44 includes the wire mesh 45 and the resin that are integrally shaped. The resin of the resin net 44 of the present embodiment is, for example, polypropylene. It should be noted that the resin for the resin net 44 is not limited to this. Where the cleaner element (filter paper) 42 can be sufficiently protected and reinforced, the wire mesh 45 can be omitted and the resin net 44 may be formed only of a resin.

The linear members 52 of the resin net 44 have external surfaces, at least outer surface portions of which, the outer surface portions partially forming a cylindrical surface of the outer periphery of the filter part 40, are smooth. The term “smooth” used herein means a surface roughness that can be usually obtained when a resin is molded.

In this embodiment, each of the mesh openings 44a of the resin net 44 in FIG. 10 has a width dimension d1 from 1.0 to 1.5 mm; a height dimension d2 from 1.0 to 1.8 mm; a radius of curvature R of each corner part from 0.2 to 0.6 mm; and a line width W of each linear member 52 forming the mesh openings 44a from 0.2 to 0.8 mm. It should be noted that the dimensions of the mesh openings 44a are not limited to these dimensions. The resin net 44 preferably has an aperture ratio of 40 to 60%. Where the aperture ratio is too low, it is difficult to remove the dust accumulating in the cleaner element (filter paper) 42 for maintenance. Where the aperture ratio is too high, grass clippings can pass through. For example, in a porous cylindrical member having a plurality of punch holes, grass clippings may stick to such a cylindrical member because it would have a low aperture ratio.

Flow of the intake air I of the engine E of the present embodiment will be described. When the engine E in FIG. 1 starts operating, negative pressure is generated in the air intake passage, and the intake air I is supplied to the engine E. The intake air I flows into the introduction passage 69 through the intake port 66 in FIG. 8. Then, the screen 68 removes grass clippings and the like as the intake air flows. The intake air I entering the introduction passage 69 flows through the introduction passage 69 toward the one end.

The intake air I within the introduction passage 69 flows into the cleaner chamber 28 through the communication port 86 at the one end portion. Then, the intake air I flows within the swirling passage 35 (FIG. 6) from the one end portion to the other end portion while swirling. When flowing within the swirling passage 35, the intake air I radially passes through the filter part 40 of the cleaner unit 30 shown in FIG. 6 to enter the hollow part 30a of the cleaner unit 30. The intake air I is then purified by the filter part 40. Specifically, the resin net 44 catches the dust DU, such as grass clippings. Further, the cleaner element 42 catches small dust.

The intake air I having flown into the hollow part 30a of the filter element 30 flows through the hollow part 30a from the other end portion to the one end portion to enter the hollow part 50a of the insertion pipe 50 of the fan case 18 as shown in FIG. 5. The intake air I having flown into the hollow part 50a is supplied to the throttle body 57 of the cylinder units 6, 6 from the cleaner outlet pipe 54 through the intake pipe 56 shown in FIG. 1. After the amount of the flow of the intake air I is adjusted in the throttle body 57, the intake air I is mixed with fuel on the downstream side of the throttle body 57 and is then supplied to the cylinder units 6.

Flow of the dust DU of the engine E of the present embodiment will be described. Small dust DU that have passed through the screen 68 shown in FIG. 8 flows into the cleaner chamber 28 along with the intake air I. As shown in FIG. 4, the dust DU entering the cleaner chamber 28 flows within the swirling passage 35 along with the intake air I from the one end portion to the other end portion. The dust DU flows to the other end of the cleaner chamber 28 because the dust cannot pass through the filter part 40 of the cleaner unit 30.

The dust DU is, for example, fiber-like dry grass and is easily caught on the outer peripheral surface of the cleaner unit 30, if the outer peripheral surface is uneven. In this embodiment, since the outer peripheral surface of the cleaner unit 30 is formed by the resin net 44 having the smooth cylindrical surface made of the resin, the dust DU flows to the other end portion of the clean chamber 28 without being caught by the cleaner unit 30.

Particularly, in this embodiment, the resin net 44 has such a lattice-opening size (aperture ratio) that the resin net 44 can prevent the dust DU, such as grass clippings, from passing therethrough and can prevent the dust DU from being caught. In addition, since the resin net 44 has a smooth flat surface, the dust DU can smoothly flows over the surface of the resin net 44 without disturbing the cyclone flow.

Further, in this embodiment, since no urethane foam (sponge) as a prefilter is provided on the outer periphery of the resin net 44, there is a larger space between the cleaner case 26 and the resin net 44. This increases the flow rate of the cyclone flow and allows the dust DU to be smoothly discharged.

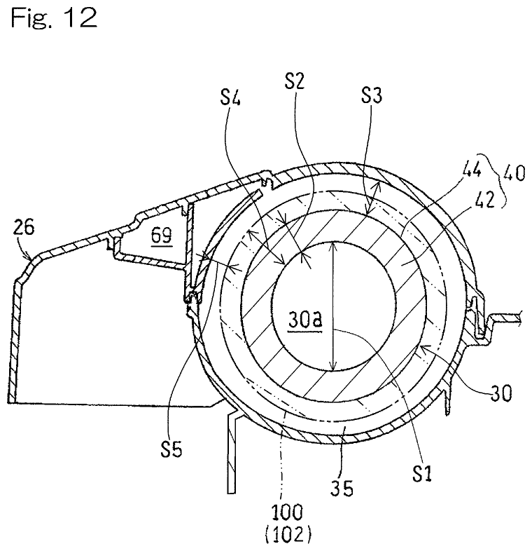

FIG. 12 shows a specific example for comparison. In FIG. 12, urethane foam (sponge) 100 as a prefilter is illustrated with double dotted lines. In a comparative example including the urethane foam 100, a filter part 102 includes a cleaner element 42 and the urethane foam 100 provided on an outer periphery of the cleaner element 42. In FIG. 12, S1 denotes a cross-sectional area of the hollow part 30a of the filter unit 30; S2 denotes a cross-sectional area of the filter part 40 of the filter unit 30; and S3 denotes a cross-sectional area, i.e., a passage area, of the swirling passage 35. S4 denotes a cross-sectional area of the filter part 102, and S5 denotes a cross-sectional area of a space between the outer peripheral surface of the urethane foam 100 and the inner peripheral surface of the cleaner case 26.

In this embodiment, S1, S2 and S3 are set to have a relation of S1<S2<S3. That is, the cross-sectional area S3 of the swirling passage 35 is larger than the cross-sectional area S2 of the filter part 40 of the filter unit 30. In contrast, in the comparative example including the urethane foam 100, S1, S4 and S5 are set to have a relation of S1<S5<S4, and the cross-sectional area S5 of the swirling passage 35 is smaller than the cross-sectional area S4 of the filter part 102. In one example, the cross-sectional areas are set to have the following relations: S1:S2:S3=1:2:3, and S1:S4:S5=1:3.5:2.5.

The dust DU is discharged from the dust discharge port 70 of the other end portion of the clean chamber 28 shown in FIG. 5, into the dust discharge passage 72 in the dust discharge pipe 74 shown in FIG. 1. The dust DU within the dust discharge pipe 74 is discharged to the outside through the one-way valve 76.

According to the above configuration, since the outer periphery of the cleaner element 42, as shown in FIG. 6, is covered by the resin net 44, the dust DU, such as grass clippings, flows over the smooth surface of the resin net 44 without being caught by the filter unit 30 and is discharged to the outside of the air cleaner. This makes it possible to prevent the dust DU from sticking to the cleaner element 42 and the wire mesh 45, thereby to prevent the air flow from being disturbed. Consequently, it is possible to prevent deterioration of performance of the filter unit 30.

Each of the corner parts 44b of the mesh openings 44a as shown in FIG. 10 forms a curved surface, i.e., has a round shape. Therefore, the dust DU, such as grass clippings, is less likely to be trapped in the resin net 44. This makes it possible to prevent the grass clippings from sticking to the cleaner element 42.

The cleaner element 42 shown in FIG. 7 includes bent filter paper, and the resin net 44 for protection is provided around the outer peripheral surface of the cleaner element 42. The resin net 44 is formed of the wire mesh 45 covered with the resin. This makes it possible to reinforce the cleaner element (filter paper) 42 with the wire mesh 45 and to prevent the dust DU, such as grass clippings, from sticking to the wire mesh 45. Where it is possible to ensure a sufficient strength for the resin net 44 made only of a resin, the cleaner element 42 that includes filter paper and has low strength can be protected with the resin net 44 made only of a resin, and the wire mesh 45 can be omitted.

As shown in FIG. 12, the cross-sectional area S3 of the swirling passage 35 is larger than the cross-sectional area S2 of the filter part 40 of the filter unit 30. Thus, the increased cross-sectional area S2 of the swirling passage 35 increases the flow rate of the cyclone flow. This facilitates discharge of the dust DU, such as grass clippings.

The present invention is not limited to the embodiments disclosed herein, and various additions, modifications, or deletions may be made without departing from the scope of the invention. For example, although the resin net 44 covers the entire outer periphery of the cleaner element 42 in the above embodiments, the resin net 44 may cover only a downstream portion of the outer periphery of the cleaner element 42. Also, the cleaner unit of the present invention can be applied to general cyclone air cleaners, and its application is not limited to use in the air cleaners having the configuration described in the above embodiments. Although the above embodiments are described with reference to a vertical air-cooled engine, the cleaner unit of the present invention can also applied to horizontal engines as well as to water-cooled engines. Further, the cleaner unit of the present invention can be applied to, e.g., single-cylinder engines, besides V-twin engines. Furthermore, the cleaner unit of the present invention may be installed in engines E other than those of riding mowers. Accordingly, such variants are included within the scope of the present invention.

### REFERENCE NUMERALS

30 . . . cleaner unit

35 . . . swirling passage

40 . . . filter part

42 . . . cleaner element (filter paper)

44 . . . resin net

44a . . . mesh opening

44b . . . corner part

45 . . . wire mesh

52 . . . linear member

S2 . . . cross-sectional area of the filter part of the cleaner element

S3 . . . cross-sectional area of the swirling passage

What is claimed is:

1. A cleaner unit for a cyclone air cleaner, the cleaner unit comprising a cleaner element and a resin net, wherein the cleaner unit has a cylindrical shape and is configured to cause outside air to swirl around an outer periphery of the cleaner unit and to be introduced through the cleaner element into a hollow part defined inside the cleaner element so as to remove dust, and
the cleaner element has an outer periphery covered by the resin net including an outer periphery part and a plurality of mesh openings, at least the outer periphery part being made of a resin.

2. The cleaner unit as claimed in claim 1, wherein each of the mesh openings has corner parts each forming a curved surface.

3. The cleaner unit as claimed in claim 1, wherein the resin net is formed of wire mesh covered with the resin.

4. The cleaner unit as claimed in claim 1, wherein the cleaner element includes bent filter paper.

5. The cleaner unit as claimed in claim 1, wherein a swirling passage between an outer peripheral surface of the cleaner element and an inner peripheral surface of a cleaner case has a larger cross-sectional area than a cross-sectional area of a filter part of the cleaner element.
